(19) United States
(12) Patent Application Publication
(10) Pub. No.: US 2003/0088475 A1
(43) Pub. Date: May 8, 2003

(54) Remote transaction and tracking protocol for internet commerce

(76) Inventors: Victor B. Goodman, Los Angeles, CA (US); Garry C. Dolley, Glendale, CA (US)

Correspondence Address: Price and Gess, Suite 250, 2100 S.E. Main Street, Irvine, CA, 92614-6238, US

(21) Appl. No.: 09/977,128

(22) Filed: Oct. 12, 2001

(51) Int. Cl. G06F 17/60

(52) U.S. Cl. 705/26; 705/39

(57) ABSTRACT

A remote transactional and tracking software protocol is presented which is able to transfer the purchase and tracking transactions from one Internet site, an original retail site, to another Internet site, the referring site, the latter operating as a virtual retail site. Using this protocol, the owner of a web browser or content site can sell items over the Internet without storing, stocking or shipping the items. Using a listing of products or services for sale, the content site owner transfers prospective purchasers who visit the content site to a retail site for inspection of the goods and to acquire additional information about the retailer's products. However, upon the commencement of a transaction on the retailer's site, the protocol routs the financial information and payment to the content (or referring) site, while separating and sending the delivery information to the retail site. Upon confirmation of a satisfactory delivery of the goods to the customer, payment of the item is made from the content site owner to the retailer less the commission.

### BACKGROUND OF THE INVENTION

1. Field of the Invention

The present invention relates generally to business methods conducted over the internet, and more particularly to a method for conducting, tracking and promoting internet commerce via a virtual retail outlet.

2. Description of Related Art

With the advent of the internet, the commercial environment has truly become a global market. At any hour of the day from the comfort of one's home, one can purchase just about anything under the sun and have the item delivered to one's home. From CDs to chocolates to movie tickets to socks, with a few clicks of a mouse one can shop safely and comfortably from the convenience of one's own home. “E-commerce” as internet commerce has come to be known has become more and more popular as a way to purchase goods, and the future appears to project continued acceleration of this phenomena.

For those who sell merchandise on the internet, computer shopping provides a terrific new vehicle to peddle one's wares. A furniture maker in Vermont can now attract and market to buyers in California without additional expenditure such as sending catalogs to everyone in the state. Rather, by promoting a web site the furniture maker can greatly expand the exposure through the internet, and attract customers from around the globe.

There are two types of commerce models that predominate the e-commerce industry, those that operate actual physical stores in addition to e-commerce, and those that do not. For example, Amazon.com does not have a store aside from its internet site, while BarnesandNoble.com is part of a larger business that also sells books at book stores. However, in either model the internet version requires the virtual store to inventory books at a warehouse and to ship books. It also requires the virtual store to maintain a website and an online catalog which must be updated regularly. Each of these functions costs money and reduces the overall profit of the internet store.

The need to maintain warehouses and to incur shipping costs and delivery costs are necessary elements of every transaction of this type, but these costs influence the overall profitability of these businesses. However, for an internet business hoping to maximize profits the cost-incurring “requirements” of the transactions are ideally something to be left to others. The present invention allows such a business to accomplish this objective.

While many internet users use the medium with the specific intent of shopping, a large percentage of internet users access the internet for information and entertainment. These web users typically initiate their session by visiting a search engine to access content-based web sites to obtain information and entertainment. This concept led to the proliferation of affiliate marketing, i.e., marketing of one's products on another's content sites. Affiliate marketing is promoted by retailers to take advantage of the high traffic on the content sites to promote their products, sharing the revenue with the content site owner in exchange for space on their web page. Affiliate marketers gained popularity with many content sites because it provided them with a method to subsidize their web site by “selling” merchandise to those users who visit their site, without the need for storing, stocking, or shipping merchandise. In many cases, however, the content site was not paid for promoting and redirecting the visitor to the retailer's site unless a sale was consummated.

As easily seen, there are several drawbacks to affiliate marketing from the content site's perspective because the system is heavily skewed in favor of the retailer. One problem is that the content sites have to establish an account with each retail site with which it is affiliated. Also, each retailer typically has its own commission structure that is in most cases weighted in favor of the retailer. The content site may only be compensated for the initial visit by the web user to the retailer's site, even though he may frequently revisit after being initially referred by the content site. An additional drawback to this arrangement from the content site owner's perspective is that the retailer controls the money.

Affiliate marketing was one of the first features of the commercial internet, and continues to be an important element in driving the e-commerce. The retailers enjoy the fact that the commissions are tied to the sales the content site generates, making the operation relatively risk free for the retailer. However, while the retailers enjoy the benefits of this risk free arrangement, the content site and the web browser operators are left with a poor deal.

### SUMMARY OF THE INVENTION

The present invention addresses the shortcomings of the just described system from the content site's position. In the present invention, a remote transactional and tracking software protocol is presented which is able to transfer the purchase and tracking transactions from one Internet site, a retail site, to another Internet site, the referring or “host” site, the latter operating as a virtual retail site. Using this protocol, the owner of a web browser or content site can sell items over the Internet without storing, stocking or shipping the items. Using a listing of products or services for sale, the content site owner transfers prospective purchasers who visit the content site to a retail site for inspection of the goods and to acquire additional information about the retailer's products. However, upon the commencement of a transaction on the retailer's site, the protocol routs the financial information and payment to the content (or referring) site, while separating and sending the delivery information to the retail site. Upon confirmation of a satisfactory delivery of the goods to the customer, payment of the item is made from the content site owner to the retailer less the commission. As just described, the content site is akin to a virtual retail store that has purchased each item on consignment, and therefore has very little risk involved. Further, the content site does not require outlays for storage facilities or shipping costs, since those costs are still borne by the retailer.

### BRIEF DESCRIPTION OF THE DRAWINGS

The exact nature of this invention, as well as its objects and advantages, will become readily apparent upon reference to the following detailed description when considered in conjunction with the accompanying drawing.

FIG. 1 is flow chart illustrating the actions taken in the present invention.

### DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide a protocol for tracking transactions and purchasing goods and services over a global network.

The present invention provides an array of tracking, administrative, quality control and accounting functions most of which are fully automated. On a web site such as a web browser or web page with a catalog listing and corresponding links to retail sites, the present invention's protocol software is loaded and the traffic on this host site will naturally direct a percentage of the visitors to access a particular retail web page that may include pictures and product descriptions of items available for sale. Of those users that decide to visit the retail web site, a percentage of those users will actually make a purchase of the available merchandise. A purchase of this type will typically involve two steps, a payment step and a delivery step. To complete the payment step, the user will typically enter in credit information such as account numbers, expiration dates, billing addresses, and any authorization information that may be required. A screen that includes the relevant fields is provided to the user to fill out the requisite data. After the payment data has been entered, a second step involving the destination and shipping charges are established. A second screen is provided that includes all the data for shipping the product to the buyer.

The present invention deviates from the normal pattern by including a switching protocol that detects when an internet user has been referred to the retail site from a host site. This important characteristic allows the present invention to transfer the financial information and payment itself to the referring (host) web site. At the same time, the switching code sends all the shipping information to the retail site for delivery. This allows the content site (host site) to control the money that it has generated for the retail site, and the content site holds the money until a delivery has been made. At that point, the money is transferred to the retailer less a predetermined commission.

The advantages of the above described method are easy to appreciate. The retail site maintains its own e-commerce site, and uploads and maintains its accounting page and catalog of products. Upon confirmation of the transaction between the user and the retailer, the code of the present invention transfers control of the payment information to the original web site owner. The completion of the transaction results in the money being deposited in the bank account of the original web site owner, while the shipping information is sent to the retailer's site. A tracking record is made available automatically to the host site and the retailer's site. The tracking software thus captures the money as well as the tracking data, and records important sale's information.

The present invention is generally characterized as a remote transactional protocol for Internet e-commerce. Currently the only way used to sell products and services on the internet is to either to create a web site and then use various means to attract customers, or to sell the products and services through an affiliate program whereby another web page operator acts as an agent for a commercial or vendor site. In contrast, the present invention allows the original host site to participate in a transaction and collect the money from the transaction and control a transaction occurring on another's remote site. It is an alternative mode to generate revenue from a web site by directing web users to web merchants sites and then capitalizing on the business the host site generates. The present approach is in contrast with affiliate-type programs, where the transaction occurs on the remote e-commerce site and then a commission is paid to the original host (sending) site. In the present invention, the sending site actually completes the e-commerce transaction and controls the money and the commission.

The following discussion demonstrates how a site may become an invention site. Generally, a content site such as a web browser or other site sets up a special web page with software codes or scripts for downloading. The scripts are to be copied and pasted into retail web site's programming, thereby converting the site into a cooperating vendor site. By recruiting a retail site to access the software acquisition site, thereby entering into a relationship whereby the retailer allows the host site to collect funds in exchange for advertising and referral services, the necessary link is complete. A few definitions facilitate a description of the present invention. The “software acquisition site” is an accessible web page that includes the programs and instructions for transferring and installing the code for the present invention. The “vendor site” is a remote web page that sells products and/or services over the Internet. The “host site” is a web browser or web page with multiple links to vendor sites that a user can use to find the products and services it seeks. The vendor site obtains the code from the software acquisition site and adds it to its own, which affects the interaction between the host site and the vendor site, as explained in more detail below.

The software to be loaded onto the vendor site is explained herein. The software that is located on the software acquisition site may be developed using an operating system, and it is preferably programmed in PHP. The code below is an illustration of the software acquisition site showing instructions for converting the host site to an invention-capable site. The steps are shown below.

Step 1: Cut and paste the JavaScript code into the order page of the vendor's site.

| <script language=‘JavaScript’> | |
|---|---|
| <!-- | |
| //////////////////////////////////////////////////////////// | |
| // Dear Associate website, | |
| // | |
| // Please configure your shopping cart software to fill in the | |
| // following fields. | |
| // | |
| // You will need to change FORM_TAG (done by cut & paste), | |
| // total_tax, total_shipping_cost, grand_total | |
| // (all 3 done by your software), thank_you_page (you fill in), | |
| // and error_page (you fill in). | |
| // | |
| // Example -- please change to suit your site. | |
| var FORM_TAG=‘<FORM ACTION=“/cgi-bin/order.cgi” METHOD=“POST”>’ | |
| var total_tax=‘<br> | |
| <b>Warning</b>: | Undefined variable: tax in |

<b>/home/httpd/html/sample.com/program/instructions.php</b>on line <b>62</b><br>

| ‘ | |
|---|---|
| var total_shipping_cost=’<br> | |
| <b>Warning</b>: | Undefined variable: shipping in |

<b>/home/httpd/html/sample.com/program/instructions.php</b>on line <b>63</b><br>

| ‘ | |
|---|---|
| var grand_total=’<br> | |
| <b>Warning</b>: | Undefined variable: total in |

<b>/home/httpd/html/sample.com/program/instructions.php<b>on line <b>64</b><br>

‘
// You may optionally give the URL to a custom “Thank you for
// your order” page and a page that displays an error (i.e. if
// the customer's credit card declines). The thank you page
// will automatically be passed the Order ID as a HTTP GET
// variable called ‘order_id'. Your thank you page should
// display this variable to the user (it's real easy in PHP).
// The error page will likewise be passed an HTTP GET variable
// called ‘error_status’ which will contain the error message.
//
// If you leave these blank, a default page will be displayed to
// your customer.
var thank_you_page=“
var error_page=”
////////////////////////////////////////////////////////////
// Put in the block of HTML that takes your customer's credit
// card here. If you do not take the credit card on the same
// page, leave this variable blank.
// It is important that if you use more than one line for this
// variable (like we have in the example below), you must put
// a ‘\' at the end of each line.
var cc_fields_block=‘\
<hur>\
\
Credit Card Number: <input type=text name=ccnum><br>\
Credit Card Exp.: <input type=text name=ccexp><br>(mm/yy)\
Name on Card: <input type=text name=ccname><br>\
\
’;
// DO NOT MODIFY BELOW THIS LINE
// -----------------------------
// Default to regular mode
var HG_ClickThru = 0
// Cycle through cookies looking for “Associate”
if(document.cookie !=“”) {

Cookies = document.cookie.split(‘;’)
for(i=0; i<Cookies.length; i++) {

cookie = new Array( )
cookie = Cookies[i].split(“=”)
// Debug
// document.write(“|” + cookie[0] + “|=>” +cookie[1] + “|<br>\n”)
// Trim leading & trailing white space
if(cookie[0].indexOf(“HG_VID”) !=−1) {

cookie[0] = “HG_VID”

}
//if((cookie[0] == “Associate”) && (cookie[1] == 1)) {
if(cookie[0] == “HG_VID”) {

HG_ClickThru = 1
HG_VID = cookie[1]

}

}

}
if(HG_ClickThru) {

<!-- DEBUG

document.write(“<p>You came from an Associate site! Your Vendor ID is: ”+

HG_VID +“<\p>”);

//-->
FORM_TAG=‘<FORM

ACTION=“http://www.sample.com/program/process_order.php4” METHOD=“POST”>\n'

| | |
|---|---|
| FORM_TAG=FORM_TAG+’<INPUT TYPE=HIDDEN | NAME=total_tax |

VALUE=‘+total_tax+‘>’;

| | |
|---|---|
| FORM_TAG=FORM_TAG+‘<INPUT | TYPE=HIDDEN |

NAME=total_shipping cost VALUE=’+total_shipping_cost+‘>’;

| | |
|---|---|
| FORM_TAG=FORM_TAG+‘<INPUT TYPE=HIDDEN | NAME=grand_total |

VALUE=’+grand_total+‘>’;

| | |
|---|---|
| FORM_TAG=FORM_TAG+‘<INPUT | TYPE=HIDDEN |

NAME=thank_you_page VALUE=’+thank_you_page+‘>’;

| | |
|---|---|
| FORM_TAG=FORM_TAG+‘<INPUT TYPE=HIDDEN | NAME=error_page |

VALUE=’+error_page+‘>’;

| | |
|---|---|
| FORM_TAG=FORM_TAG+‘INPUT TYPE=HIDDEN | NAME=vid |

VALUE=’+HG_VID+‘>’;

} else {

<!-- DEBUG
document.write(“<p>You didn't come from an Associate site.</p>\n”); //-->

}
//-->
</script>

Step 2: Modify the JavaScript (FORM_TAG variable) by setting the form tag from the order page to the JavaScript of Step 1. For example, a form tag may take the form of:

<FORM ACTION=‘/cgi-bin/order.cgi’ METHOD=‘POST’>

This line is cut and pasted where the FORM_TAG variable appears in the JavaScript, such as:

var FORM_TAG=<FORM ACTION=‘/cgi-bin/order.cgi’ METHOD=‘POST’>

Where the FORM tag was cut, the following JavaScript is pasted:

<script language=‘JavaScript’>

<!--

document.write(FORM_TAG)

//-->

</script>

Step 3: Modify other JavaScript variables. On the block of JavaScript copied from Step 1, there are three variables that will be filled in by the vendor site's order information (also known as “shopping cart”) software. These variables are “total_tax”, “total_Shipping_cost”, and “grand_total”. An example of how this is accomplished in PHP is as follows:

var total_tax=‘<?echo $tax ?>’

var total_shipping_cost=‘<?echo $shipping ?>’

var grand_total=‘<? echo $total ?>’

where the variables $tax, $shipping, and $total are passed from the previous page. Because there are many different shopping cart softwares available, the foregoing may be tailored to the specific software to pass the above values into the JavaScript variables.

Step 4: Remove credit card information from Vendor's site. Since the host site will actually process the order for the vendor site when the customer has been referred by a designated host site, the vendor site's portion of the order form requesting credit card information should be removed in this case. This step is similar to step 2, where lines in the vendor site's order page are cut. For example:

Credit Card Number:<input type=text name=ccnum>

Credit Card Exp.:<input type=text name=ccexp>

(mm/yy) Name on Card:<input type=text name=ccname>

These lines are pasted where the cc_fields_block variable in the first JavaScript block appear. For example:

var cc_fields_block=’\

Credit Card Number:<input type=text name=ccnum>\

Credit Card Exp.:<input type=text name=ccexp>(mm/yy)\

Name on Card:<input type=text name=ccname>\

Where the credit card fields appeared originally, the following JavaScript should be pasted:

<script language=‘JavaScript’><!- - if(!HG_ClickThru) (document.write (cc_fields_block))//- -></scrip

Step 5: Copy a script in the DOCUMENT_ROOT of the vendor site that sets a cookie on the user's browser when the user has come to the vendor site from a designated host site.

The foregoing instructions are for the vendor site to enable the present invention to function on that site. It is primarily a code that allows a dynamic switch of a transaction across the internet. After these steps are taken on the vendor's order page, if users go to the vendor's site on their own (i.e., not through a site employing the present invention), the users will go to the order page and order the product as a normal transaction. In this case, the vendor will take care of all the credit card transactional functions, billing, tracking, etc. However, when a user reaches the vendor site through a host site using the present invention, the code copied from the steps 1-5 will switch the financial portion of the transaction to the host site. The credit card billing will no longer be completed by the vendor, but rather will be completed by the host site. The transfer of the resulting transaction is completely transparent to the customer, i.e., the customer is unaware that the host site is receiving the money rather than the retail site.

An object of the present invention is to implement a search engine, or site that has a number of links to various other sites on it, and have users visit other sites. The search engine site, by its very nature, enables a commercial relationship between itself and the vendor sites that it sends the users to. The shortcoming of existing search engines is that even though the search engine has created an opportunity for commerce by directing potential buyers to the vendor's site, the search engine doesn't participate directly in the commerce. When a person who is surfing on a search engine site enters a search for “strollers,” causing the web user to be sent to a “stroller” site, the search engine that has sent the user there receives no credit for a sale should the user purchase a stroller. The present invention addresses this issue.

The present invention does not affect the way users browse the site, or what is presented on the vendor's site. The user who has arrived from a host site to a vendor's site can shop the vendor's site as is customary with typical vendor sites. Should the user decide to make a purchase, the user is usually directed to a transaction page to complete the purchase. When the user goes to the vendor's transaction page, the software remains inactive initially. However, when the user takes a predetermined affirmative step to consummate a purchase, the present invention transfers the user to the host site to complete the economic portion of the transaction so that the host site/search engine can collect the money.

To indicate to the retail site that a transfer should occur, the web user's computer must be tagged somehow to indicate that it has arrived from an invention-supplied host web site. To achieve this, the vendor's site sets a small file, known as a cookie, on the visitor's hard drive when the vendor's site recognizes that the user has come from a designated host site. This file signals to the ordering page of the retail site that the user was directed to the vendor's website by a search engine or other web page employing the present invention. When prompted for the credit card information, the transactional page on the vendor's website that queries the user for the credit card number and the authorization of the funds instead transfers the user dynamically to a similar page on the host site to perform this operation. The second, small script downloaded on the host site refers web users that are transferred to the vendor site from the host site to a slightly modified site instead. That is, the universal resource locator (URL) link on the host site will not simply be CERTAINPRODUCT.COM, but rather the URL link will be CERTAINPRODUCT.COM/ followed by the downloaded script name as well as some other variables. The original link is slightly modified in order to call this script, which the vendor has downloaded. After the calling of the script, because the link was modified, when users click on the link to go to, using our example, CERTAINPRODUCT.COM, this link sets a cookie on their browser. At this point, the user can then browse the CERTAINPRODUCTS.COM site without any indication of the tracking software. However, at the point of purchase, for example at the order confirmation page, the vendor's web page includes the cut and pasted HTML and JavaScript code described above. On the instruction page, that code corresponds to Step 1, Step 2, and Step 3.

When a user goes to the order page, the code first checks to see if the cookie is present. If it is, the action of the form tag variable, which is referenced in Step 2, no longer directs the user to CERTAINPRODUCT.COM order acquisition page, but rather directs the user to host site's credit card number acquisition page. The change of that variable controls the switching operation. Under Step 3, the vendor website operator modifies the JavaScript variables to allow the host site to ascertain how much to charge for tax, how much to charge for shipping, and the amount of the total cost to the purchaser.

Under Step 4, which is entitled “Take Out Credit Card Number Acquisition”, the program causes the vendor site to remove the three or four fields for entering credit card information such as name, number, and expiration date. The fields are replace by a JavaScript variable, referenced as cc_fields_block. There is also a small script that will print out the credit card acquisition fields if the user did not come through the host site. If the vendor site web user did not come from the host site, then the regular credit card number fields will appear on the order page so that the vendor site can take care of the payment operation. If the visitor did come through the host site, those fields will no longer be displayed, and the credit card number, expiration date, name, credit card type, etc. will be acquired from the visitor upon transfer to the host site (such as after clicking a confirm order link). The transfer to the host site is accomplished because of the modification of the form tag by the JavaScript in Step 1.

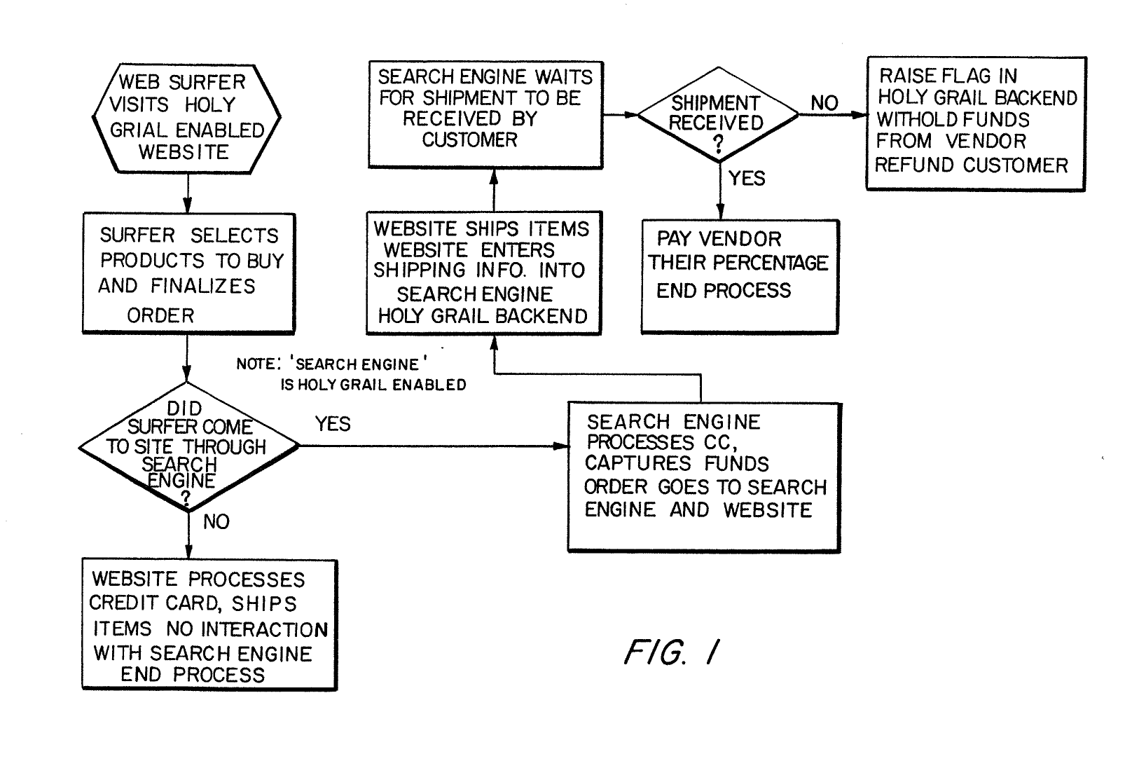

FIG. 1 is a flow chart of the process of the present invention. The first box represents a web user activating a site such as a web browser or content page with multiple links to different retail internet sites. The user clicks on one of the sites, and the second box corresponds to the decision to make a purchase at one of the retail internet sites arrived at by way of the web browser. At the point where the purchase has been confirmed, the decision is made in the third box whether the user came to the site through one of the search engines enabled with the present invention. If not, the purchase is transacted as a normal purchase with no implications from the present invention as represented in the fourth box. If the user did come from a site with the present invention, the fifth box represents the action of the transaction page where credit information control is dynamically transferred to the host site to charge the customer for the ordered goods and collect the money. The host site informs the retail site that an order has been placed and the money has been collected, and requests that the retail site ship the goods. In the sixth box, the retail site ships the goods, and transmits the shipping information to the host site for cataloging. The seventh box corresponds to a check to see if the shipped goods are received by the customer. If they are, the funds (less a percentage agreed upon between the parties) are transferred to the retail site and the process ends in box eight. If the goods are not received, box nine shows that the funds are withheld from the retail site and a flag is raised in the host site database.

A unique aspect of the present invention allows a website, using the previous fictional example, CERTAINPRODUCTS.COM, to function fully and independently and to allow people to buy from CERTAINPRODUCTS.COM, regardless of whether the visitor was directed to the vendor's site by the host site or not. This allows the vendor to keep his website integrity in that it is not dependent upon the host site. It allows the vendor to do both types of transactions concurrently. For example if a vendor site has 10,000 people a day visiting the site from other websites, or from advertising, any transactions that may occur can be credited correctly to their normal e-commerce partner. But if there's one that comes from the host site, the transaction switching occurs.

The present invention permits the tracking of visitors through one site, i.e. a host site, and then dynamically modifies HTML and JavaScript code on another site, such as a vendor's site, in order to dynamic switch an e-commerce transaction. Although the programming to achieve the objects of the present invention can be varied, the inventors have found JavaScript to be a good tool for accomplishing the objects, along with some HTML within the JavaScript. In Step 5, the code which is downloaded to set the cookie, has been achieved with a Perl version and a PHP version. ASP versions are adapted for users running servers on all current operating systems are possible.

PHP is an embedded HTML scripting language. The host site installs this software package and runs it as users use the host site to visit vendor web pages that allow the users to find the products they want to buy. The software manages a database that catalogs the transactions for the host site operator, such as the amounts of money that is transferred, the names, addresses and contact information of all the vendors that the host site has accumulated, and generates a reporting page to tell the host site to whom money is owed. In a preferred embodiment the program that controls the functions of the host site is all written in PHP.

The small file placed on the user's hard drive, also known as a cookie, is set by the script that is downloaded in Step 5 and acts as a logical variable. The name of the cookie is “HG_set”. If the value is “1” meaning “true”, then the order page of the vendor site will automatically switch to the host site at credit card information acquisition. If it's set to “zero” or “non-existent”, no switching will occur and the vendor site will conduct the transaction in its normal fashion.

The system can be thought of as having two components. On the server side, or host site, the actual software is made available for distribution to interested host sites for installation on their server. The client side of the model is the vendor site. This side consists of the JavaScript code copied in Steps 1 through 4 and the cookie installation scripts installed in Step 5.

To implement the server side of the invention, an administrative web page is preferably used to acquire information regarding the vendor/host relationship. For example, the host site operator can search a vendor database by vendor I.D., vendor password, vendor name, address, city, state, postal code, contact phone number, fax number, e-mail address, or the percentage net due. The host site needs to collect a vendor's data before it can use the JavaScript code.

Another option available on the administration page is an option labeled “Transactions”. The main purpose of the “Transactions” page is to allow the host site administrator the ability to search for transactions that have transpired using any of the stored criteria. They can search for transactions by the transaction date, the shipping date, the received date of the items, or by whether certain flags are set on the transaction, i.e., failed payment, bad vendor, or customer complaint. They can also search by transaction I.D., vendor I.D., date, tracking number, shipping cost, tax, subtotal, grand total, credit card number, credit card expiration date, shipping date, received date, order job, and comments. The purpose of this Transaction Administration page is to give the host site operator the ability to completely track down or search any transactions that may have occurred on any its vendor sites. This includes the ability to track the customer satisfaction for customers who are purchasing product through an affiliated vendor using the host site, and to track the status of a delivery provided by the Transaction option. Thus the software gives host site the opportunity to recall up to the minute information for tracking, not only of the economic part of the transaction, but also of the customer fulfillment.

A third option on the administrative page is “Net Due Vendor”. The purpose of this operation is to be able to find out how much money the host site owes to a vendor site for any given period of time. The “Summary Net Due Vendor” option allows the operator to select any of the vendors and then click “This Month” button, which informs him of the amount of money owed to that vendor for the current month. Other options include searches through transaction I.D., vendor I.D., date of the transaction, shipping cost, tax, subtotal, grand total, total net due, comments, whether the transaction has been paid or has not been paid, by the date paid, or by the check number associated with any pay outs. One can also list all paid transactions and all unpaid transactions.

A page can also be created to track the various transactions and to find out details of the respective vendor balances. A login page displays fields for the vendor I.D. and password. This allows access to the statistics and, importantly, allows the adding of the tracking number for the respective transaction as well as a date that the goods were shipped. When a customer responds that a shipment was not received, the host site operator can review the tracking number and the date the vendor shipped it and then determine if a problem has occurred. This page also allows the site operator to review each of the transactions that have occurred on his site so that he can find information such as the customer's residence, the specific goods ordered, and so forth.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

We claim:

1. A method for performing transactions over the internet comprising the steps of:
providing a host web site capable of routing web users from the host web site to other web sites;
arranging with a cooperating vendor web site to accept payment from the host web site in return for the vendor web site's fulfillment of a customer purchase request made by a customer routed to the vendor web site via the host web site;
providing software to be installed on the vendor web site to recognize when a customer has been routed to the vendor web site from the host web site;
requesting and obtaining customer's payment information by the vendor web site after an affirmative act by the customer is made to make a purchase on the vendor's web site;
transferring customer's payment information from the vendor web site to the host web site when the software on the vendor web site has determined that the customer has been routed to the vendor web site from the host web site;
collecting the funds for the transaction by the host web site using the customer's payment information transferred in the preceding step;
requesting and obtaining additional information necessary to fulfill the customer's purchase request by the vendor web site;
fulfilling the customer's purchase request by the vendor web site; and
transferring a percentage of the funds collected by the host web site to the vendor web site upon completion of the preceding step

2. The method for performing transactions over the internet of claim 1 wherein the host site can route web users to a plurality of vendor sites.

3. The method for performing transactions over the internet of claim 2 wherein the step of fulfilling a customer's purchase request comprises the act of shipping a product to the customer.

4. The method for performing transactions over the internet of claim 1 further comprising a step for storing information with respect to a plurality of transactions.

5. The method for performing transactions over the internet of claim 1 wherein the step of recognizing recognize when a customer has been routed to the vendor web site from the host web site comprises the recognition of a cookie placed on the customer's computer by the host web site.

6. The method for performing transactions over the internet of claim 1 further comprising the step of creating a modified URL of the vendor's web site to distinguish customer's routed from the host web site from customers not routed from a host web site.

7. The method for performing transactions over the internet of claim 1 further comprising the step of generating a report indicating funds owed to vendor web sites by the host web site.

8. The method for performing transactions over the internet of claim 2 further comprising the step of generating a database of information collected from the vendor web sites.

9. The method for performing transactions over the internet of claim 1 further comprising the step tracking the status of each transaction, where the status can be obtained by commands on the host web site.
